(19) United States
(12) Patent Application Publication
(10) Pub. No.: US 2026/0225673 A1
(43) Pub. Date: Aug. 6, 2026

(54) ROBOT, ROBOT CONTROL METHOD AND APPARATUS, ELECTRONIC DEVICE, COMPUTER STORAGE MEDIUM, AND COMPUTER PROGRAM PRODUCT

(71) Applicant: Tencent Technology (Shenzhen) Company Limited, Shenzhen (CN)

(72) Inventors: Dongsheng ZHANG, Shenzhen (CN); Xiong Li, Shenzhen (CN); Yufeng ZHANG, Shenzhen (CN); Zhengyou ZHANG, Shenzhen (CN)

(21) Appl. No.: 19/635,323

(22) Filed: Mar. 31, 2026

Related U.S. Application Data
(63) Continuation of application No. PCT/CN2024/137842, filed on Dec. 9, 2024.

(30) Foreign Application Priority Data
Jan. 25, 2024 (CN) 202410108694.4

(51) Int. Cl. B62D 57/028; B25J 5/00; B62D 61/12

(52) U.S. Cl. CPC B62D 57/028; B25J 5/007; B62D 61/12

(57) ABSTRACT

This application provides a robot, a robot control method performed by an electronic device. The robot includes: a base, a robot body, a leg assembly and a support chassis. One end of the robot body is connected to the base by using a first connector. The leg assembly includes mechanical legs, and one end of each leg is connected to the base by using a respective second connector. A first rotating shaft is disposed on a first mechanical leg of the plurality of mechanical legs. The first rotating shaft is configured to connect a support chassis. The support chassis includes a first surface and a second surface. First moving wheels are disposed on the first surface of the support chassis. The first rotating shaft rotates to cause the support chassis to form a first relative position and a second relative position with respect to the first mechanical leg.

### CROSS-REFERENCE TO RELATED APPLICATIONS

This application is a continuation application of PCT Patent Application No. PCT/CN2024/137842, entitled “ROBOT, ROBOT CONTROL METHOD AND APPARATUS, ELECTRONIC DEVICE, COMPUTER STORAGE MEDIUM, AND COMPUTER PROGRAM PRODUCT” filed on December 9, 2024, which claims priority to Chinese Patent Application No. 202410108694.4, entitled “ROBOT, ROBOT CONTROL METHOD AND APPARATUS, ELECTRONIC DEVICE, COMPUTER STORAGE MEDIUM, AND COMPUTER PROGRAM PRODUCT” filed on January 25, 2024, all of which is incorporated herein by reference in their entirety.

### FIELD OF THE TECHNOLOGY

This application relates to robot and artificial intelligence technologies, and in particular, to a robot, a robot control method and apparatus, an electronic device, a computer storage medium, and a computer program product.

### BACKGROUND OF THE DISCLOSURE

In the related art, with continuous development of robot technologies, the movement capability of a robot has garnered significant attention. The movement capability of the robot is the basis for placement of the robot into different scenarios for use. In the related art, the robots move either in a legged or wheeled locomotion manner. This single locomotion manner affects the stability of locomotion of the robots in different scenarios and impedes working efficiency of the robots.

In the related art, there is no good manner to improve the stability of locomotion of robots in a complex environment.

### SUMMARY

Embodiments of this application provide a robot, a robot control method and apparatus, an electronic device, a computer storage medium, and a computer program product, so as to improve the stability of locomotion of the robot in a complex environment.

Technical solutions of the embodiments of this application are implemented as follows:

An embodiment of this application provides a robot, including: a base, a robot body, a leg assembly and a support chassis;

one end of the robot body being connected to the base by using a first connector;

the leg assembly including a plurality of mechanical legs, and one end of each of the mechanical legs being connected to the base by using a respective second connector;

a first rotating shaft being disposed on a first mechanical leg of the plurality of mechanical legs, the first rotating shaft being configured to connect the support chassis, the support chassis including a first surface and a second surface, first moving wheels being disposed on the first surface of the support chassis, and the first rotating shaft rotating to cause the support chassis to form a first relative position and a second relative position with respect to the first mechanical leg;

in the first relative position, the first moving wheels being configured to contact a support surface; and

in the second relative position, the second surface of the support chassis being configured to contact the support surface.

An embodiment of this application provides a robot control method, the method being configured for controlling the robot according to the embodiment of this application, and the method including:

obtaining environment information of a current environment of the robot;

controlling, in response to the current environment of the robot meeting a first contact condition, the first rotating shaft of the first mechanical leg of the robot to rotate the support chassis to form the first relative position; and

controlling, in response to the current environment not meeting the first contact condition, the first rotating shaft of the first mechanical leg of the robot to rotate the support chassis to form the second relative position.

An embodiment of this application provides a robot control apparatus, the apparatus being configured to control the robot according to the embodiment of this application, and the apparatus including:

an obtaining module, configured to obtain environment information of a current environment of the robot; and

a switching module, configured to control, in response to the environment information of the environment of the robot meeting a first contact condition, the first rotating shaft of the first mechanical leg of the robot to rotate the support chassis to form the first relative position;

the switching module being further configured to control, in response to the environment information not meeting the first contact condition, the first rotating shaft of the first mechanical leg of the robot to rotate the support chassis to form the second relative position.

An embodiment of this application provides an electronic device, including:

a memory, configured to store computer-executable instructions or computer programs; and

a processor, configured to implement, when executing the computer-executable instructions or the computer programs stored in the memory, the robot control method provided in the embodiment of this application.

The embodiments of this application have the following beneficial effects:

The body and the mechanical legs of the robot are connected by using the base, so that the mechanical legs and the body of the robot are independent of each other, thereby increasing the flexibility of the robot. The plurality of mechanical legs support the body based on the base. The robot is provided with the plurality of mechanical legs, to enhance balance and stability of the robot. Ends of the plurality of mechanical legs contact the support surface, to meet requirements of more different terrain environments and facilitate the robot to adapt to different environments. The first mechanical leg is disposed in the plurality of mechanical legs, and the first mechanical leg includes the support chassis and the moving wheels, which enables the robot to switch between different support manners. When the plane supporting the floor is in contact with the support surface, the stability of the robot can be improved. When the moving wheels are in contact with the support surface, the moving speed of the robot on the support surface can be improved. The switching between different support manners improves the universality of the robot in the complex environment, thereby improving the working efficiency and moving efficiency of the robot.

### BRIEF DESCRIPTION OF THE DRAWINGS

FIG. 1A is a schematic diagram of a first application mode of a robot control method according to an embodiment of this application.

FIG. 1B is a schematic diagram of a second application mode of a robot control method according to an embodiment of this application.

FIG. 2A is a schematic structural diagram of a terminal device according to an embodiment of this application.

FIG. 2B is a schematic structural diagram of a robot according to an embodiment of this application.

FIG. 3 is a schematic flowchart of a robot control method according to an embodiment of this application.

FIG. 4A is a first schematic structural diagram of a robot according to an embodiment of this application.

FIG. 4B is a second schematic structural diagram of a robot according to an embodiment of this application.

FIG. 4C is a third schematic structural diagram of a robot according to an embodiment of this application.

FIG. 4D is a schematic structural diagram of a leg assembly of a robot according to an embodiment of this application.

FIG. 4E is a first schematic structural diagram of a robot body of a robot according to an embodiment of this application.

FIG. 5A is a first schematic structural diagram of a base and a leg assembly of a robot according to an embodiment of this application.

FIG. 5B is a second schematic structural diagram of a base and a leg assembly of a robot according to an embodiment of this application.

FIG. 5C is a schematic diagram of a first mechanical leg of a robot in a fifth relative position according to an embodiment of this application.

FIG. 5D is a first schematic diagram of a first mechanical leg of a robot in a fourth relative position according to an embodiment of this application.

FIG. 5E is a second schematic diagram of a first mechanical leg of a robot in a fourth relative position according to an embodiment of this application.

FIG. 5F is a third schematic structural diagram of a base and a leg assembly of a robot according to an embodiment of this application.

FIG. 5G is a fourth schematic structural diagram of a base and a leg assembly of a robot according to an embodiment of this application.

FIG. 6 is a second schematic structural diagram of a robot body of a robot according to an embodiment of this application.

FIG. 7A is a first schematic structural diagram of a support chassis of a robot according to an embodiment of this application.

FIG. 7B is a second schematic structural diagram of a support chassis of a robot according to an embodiment of this application.

FIG. 7C is a third schematic structural diagram of a support chassis of a robot according to an embodiment of this application.

FIG. 7D is a fourth schematic structural diagram of a support chassis of a robot according to an embodiment of this application.

FIG. 8 is a schematic structural diagram of a machine learning model according to an embodiment of this application.

FIG. 9A is a first schematic diagram of a connector according to an embodiment of this application.

FIG. 9B is a second schematic diagram of a connector according to an embodiment of this application.

FIG. 9C is a third schematic diagram of a connector according to an embodiment of this application.

### DESCRIPTION OF EMBODIMENTS

To make the objectives, technical solutions, and advantages of this application clearer, the following further describes this application in detail with reference to the accompanying drawings. The described embodiments are not to be considered as a limitation to this application. All other embodiments obtained by a person of ordinary skill in the art without creative efforts shall fall within the protection scope of this application.

In the following description, the term "some embodiments" describes subsets of all possible embodiments, but "some embodiments" may be the same subset or different subsets of all the possible embodiments, and can be combined with each other without conflict.

In the description of this application, orientation or position relationships indicated by the terms such as "center", "longitudinal", "transverse", "length", "width", "thickness", "on", "below", "front", "rear", "left", "right", "vertical", "horizontal", "top", "bottom", "inside", "outside", "clockwise", "counterclockwise", "close to", and "adjacent" are based on orientation or position relationships shown in the accompanying drawings, and are used only for ease and brevity of illustration and description, rather than indicating or implying that the mentioned apparatus or component necessarily has a particular orientation or is necessarily constructed and operated in a particular orientation. Therefore, such terms are not to be construed as limiting of this application.

The term "first/second/third" involved in the following descriptions is merely used to distinguish between similar objects and does not denote specific order of objects. Specific order or sequence of the term "first/second/third" can be interchanged where permitted such that the embodiments of this application described herein can be implemented in order other than that illustrated or described herein.

During example application of relevant data collection and processing in this application (for example, data collection of the robot on the surrounding environment), the informed consent or individual consent of a personal information subject needs to be obtained in strict accordance with the requirements of relevant national laws and regulations, and the subsequent data use and processing behavior is carried out within the scope of authorization of laws and regulations and the personal information subject.

In the embodiment of this application, the term "module" or "unit" refers to a computer program with a preset function or a part of the computer program and works, together with other related parts, to implement a preset target, and may be completely or partially implemented by using software, hardware (for example, a processing circuit or a memory) or a combination thereof. Similarly, one processor (or a plurality of processors or memories) may be configured to implement one or more modules or units. In addition, each module or unit may be a part of an overall module or unit including a function of the module or unit.

Unless otherwise defined, meanings of all technical and scientific terms used herein are the same as those usually understood by a person skilled in the art to which this application belongs. Terms used herein are merely intended to describe the embodiments of this application, but are not intended to limit this application.

Before the embodiments of this application are further described in detail, a description is made on nouns and terms in the embodiments of this application, and the nouns and terms in the embodiments of this application are applicable to the following explanations.

1) Robot: a machine that can execute a task such as a job or a movement through programming and automatic control. Robots have basic features such as perception, decision-making, and execution, and may help or even replace humans to complete dangerous, heavy, and complex work, improve working efficiency and quality, serve humans, and expand or extend the range of activities and capabilities of humans.

2) Kinematic joint: a movable connection between two components that are in direct contact and can produce relative motion. An element such as a point, a line, or a plane on the two components, that participates in contact to form the kinematic joint, is referred to as a kinematic joint element. The types include: a revolute joint, a prismatic joint, a screw joint, and a higher pair joint.

3) Prismatic joint: a kinematic joint in which two surfaces are parallel to each other and one surface slides on the other surface.

4) Revolute joint: also referred to as a turning joint, which is a type of kinematic joint and is usually denoted by the letter R. The revolute joint allows relative rotation of two components about a common axis by a rotational angle α. The vertical distance L between the two components is a constant and is referred to as an offset.

5) Direct driver: a direct rigid connection between a motor and a driven work piece, without an intermediate link such as a screw, a gear, or a decelerator.

6) Direct driver leg: two parts of a mechanism used as a leg of a robot moving along a straight line. An internally arranged bent leg refers to a mechanism used as a leg of a robot, which has a joint that enables the two connected parts to perform motions not along the same straight line.

7) Track: a flexible chain link driven by a driving wheel and surrounding the driving wheel, a load wheel, an inducer wheel, and a carrier roller. The track includes track shoes, track pins, and the like. The track pins connects the track shoes to form the track link. The track shoe is provided with holes at two ends to mesh with the driving wheel, and inducer teeth in the middle, which are configured to align the track and prevent the track from derailment during turns or lateral tilts of the robot, and a side of the track shoe in contact with the ground is provided with anti-slip ribs (also referred to as textures), so as to improve robustness of the track shoe and the adhesion between the track and the ground. In this embodiment of this application, the track includes at least a driving wheel and a flexible chain link.

8) Driving wheel: generally refers to an apparatus responsible for transferring energy from one component to another component in a mechanical system, for example, a wheel driven by a motor. In this embodiment of this application, the driving wheel in contact with the support surface can be driven by the motor to rotate, and drive the whole robot to move.

9) Driven wheel: generally refers to a wheel that has no driving force and rotates depending on driving force of another wheel (which is typically the driving wheel).

Embodiments of this application provide a robot, a robot control method and apparatus, an electronic device, a computer-readable storage medium, and a computer program product, so as to improve the stability of locomotion of the robot in a complex environment.

An exemplary application of the electronic device provided in the embodiment of this application is described below. The electronic device provided in the embodiment of this application may be implemented as various types of user terminals such as a notebook computer, a tablet computer, a desktop computer, a set-top box, a smart television, a mobile device (for example, a mobile phone, a portable music player, a personal digital assistant, a dedicated messaging device, or a portable game device), an in-vehicle terminal, a virtual reaction (VR) device, or an augmented reality (AR) device, or may be implemented as a server. An exemplary application in which the electronic device is implemented as a terminal device or a server is to be described below.

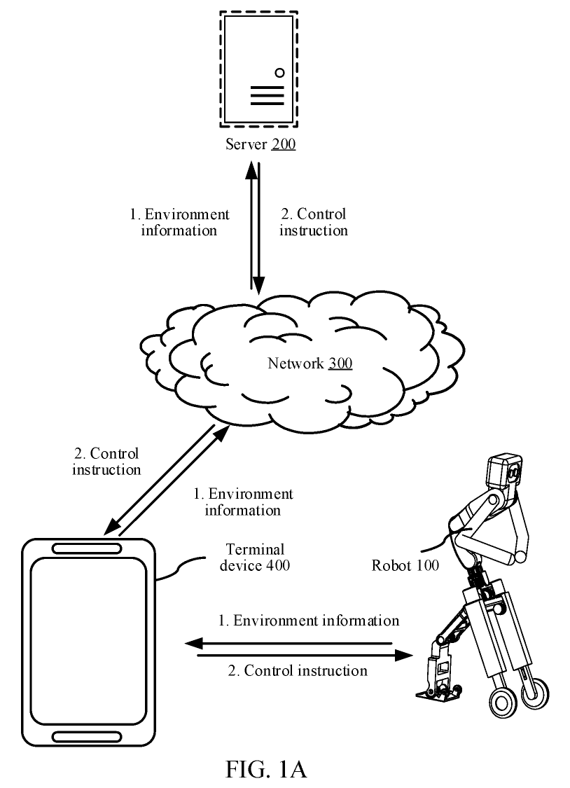

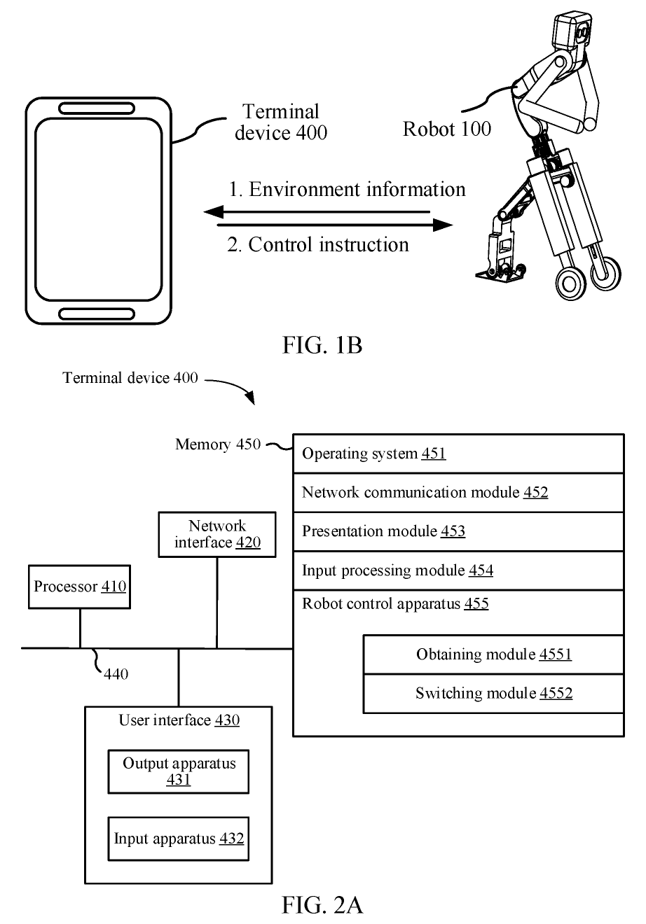

Referring to FIG. 1A, FIG. 1A is a schematic diagram of a first application mode of a robot control method according to an embodiment of this application. For example, FIG. 1A involves a robot 100, a terminal device 400, a server 200, and a network 300. The terminal device 400 may be disposed on the robot 100. The terminal device 400 is connected to the server 200 through the network 300. The network 300 may be a wide area network or a local area network, or a combination thereof.

In some embodiments, the terminal device 400 may be disposed on the robot 100, or the terminal device 400 is connected to a communication module on the robot 100 by using a short-range communication technology (such as ZigBee, Bluetooth, and WIFI). Alternatively, the robot 100 is in a wired connection with the terminal device 400 (for example, the robot is provided with a serial communication (COM) interface or a universal serial bus (USB) interface into which a data line is inserted, and is connected to the terminal device 400).

For example, a sensor disposed on the robot 100 acquires environment information and sends the environment information to the terminal device 400. The terminal device 400 sends the environment information to the server 200 through the network 300. The server 200 determines a motion control instruction of the robot according to the environment information of the environment of the robot 100. The server 200 sends the motion control instruction to the terminal device 400. The terminal device 400 sends the motion control instruction to the robot 100. The robot 100 executes a corresponding action according to the motion control instruction.

Referring to FIG. 1B, FIG. 1B is a schematic diagram of a second application mode of a robot control method according to an embodiment of this application. For example, FIG. 1B involves a robot 100 and a terminal device 400. The terminal device 400 is disposed on the robot 100, or the terminal device 400 is connected to a communication module on the robot 100 by using Bluetooth, Zigbee, or WIFI. Alternatively, the robot 100 is in a wired connection with the terminal device 400.

For example, a sensor disposed on the robot 100 acquires environment information and sends the environment information to the terminal device 400. The terminal device 400 determines a motion control instruction of the robot according to the environment information of the environment of the robot 100. The terminal device 400 sends the motion control instruction to the robot 100. The robot 100 executes a corresponding motion according to the motion control instruction.

In some embodiments, the robot controlled by the robot control method in this embodiment of this application may be applied to a place such as industry, home, or office. The robot can be applied to scenarios such as environment detection, housekeeping services, and assembly lines.

1. For the environment detection, the robot controlled by the robot control method provided in this embodiment of this application can adjust the motion state of the mechanical legs according to information about obstacles on the ground and information about ground roughness, so that the robot can move in various terrains.

2. For the housekeeping services, the robot controlled by the robot control method provided in this embodiment of this application can adjust the motion state of the mechanical legs according to environment information in a home environment, and the mechanical arms of the robot can be configured to carry an object or support a user.

3. For the assembly lines, the robot controlled by the robot control method provided in this embodiment of this application can adjust the motion state of the mechanical legs according to environment information in a working environment, and the mechanical arms of the robot can be configured to carry goods.

The embodiments of this application can be implemented by using database technology. A database, in short, can be regarded as an electronic file cabinet, i.e., a place in which electronic files are stored. Users can add, query, update, or delete data in the files or perform other operations. The so-called "database" is a collection of data that is stored together in a certain manner, can be shared with a plurality of users, has as little redundancy as possible, and is independent of application programs.

A database management system (DBMS) is a computer software system designed to manage databases, and generally has basic functions such as storage, interception, security, and backup. The database management system may be classified according to the supported database model, such as relational and extensible markup language (XML); or according to the supported computer type, such as server cluster and mobile phone; or according to the used query language, such as structured query language (SQL) and XQuery; or according to the focus of performance metrics, such as maximum scale and highest running speed; or according to other classification manners. Regardless of the classification manner used, some DBMSs can span categories, for example, supporting multiple query languages simultaneously.

In some embodiments, the server may be an independent physical server, or a server cluster or distributed system including a plurality of physical servers, or may be a cloud server that provides basic cloud computing services, such as a cloud service, a cloud database, cloud computing, a cloud function, cloud storage, a network service, cloud communication, a middleware service, a domain name service, a security service, a content delivery network (CDN), big data, and an artificial intelligence platform. The electronic device may be a smart phone, a tablet computer, a notebook computer, a desktop computer, a smart speaker, a smart watch, and the like, but is not limited thereto. The terminal device may be connected directly or indirectly to the server in a wired or wireless communication manner, which is not limited in this application.

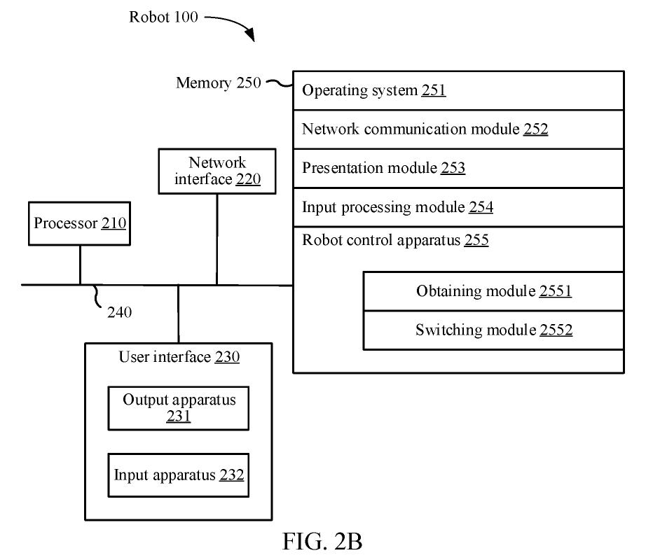

The electronic device provided in this embodiment of this application may be a terminal device. Referring to FIG. 2A, FIG. 2A is a schematic structural diagram of a terminal device according to an embodiment of this application. The electronic device provided in this embodiment of this application may be a terminal device 400. The terminal device 400 shown in FIG. 2A includes: at least one processor 410, a memory 450, at least one network interface 420, and a user interface 430. Various assemblies in the terminal device 400 are coupled together through a bus system 440. The bus system 440 is configured to implement connection and communication between the assemblies. In addition to a data bus, the bus system 440 further includes a power bus, a control bus, and a status signal bus. However, for clear description, various types of buses in FIG. 2A are marked as the bus system 440.

The processor 410 may be an integrated circuit chip, and has a signal processing capability, for example, a general-purpose processor, a digital signal processor (DSP), another programmable logic device, a discrete gate or transistor logic device, or a discrete hardware component. The general-purpose processor may be a microprocessor or any conventional processor.

The user interface 430 includes one or more output apparatuses 431 that enable presentation of media content, including one or more speakers and/or one or more visual display screens. The user interface 430 further includes one or more input apparatuses 432, including a user interface component helping a user input, for example, a keyboard, a mouse, a microphone, a touchscreen, a camera, and another input button and control.

The memory 450 may be a removable memory, a non-removable memory, or a combination thereof. Exemplary hardware devices include a solid-state memory, a hard disk drive, an optical disk drive, and the like. In some embodiments, the memory 450 includes one or more storage devices that are physically away from the processor 410.

The memory 450 includes a volatile memory or a non-volatile memory, or may include both a volatile memory and a non-volatile memory. The non-volatile memory may be a read-only memory (ROM), and the volatile memory may be a random-access memory (RAM). The memory 450 described in the embodiments of this application is to include any suitable type of memories.

In some embodiments, the memory 450 can store data to support various operations. Examples of the data include a program, a module, and a data structure, or a subset or a superset thereof, which are exemplarily described below.

An operating system 451 includes system programs for processing various basic system services and performing hardware-related tasks, for example, a framework layer, a kernel library layer, and a driver layer for implementing various basic services and process hardware-based tasks.

A network communication module 452 is configured to reach other electronic devices via one or more (wired or wireless) network interfaces 420. For example, the network interface 420 includes Bluetooth, WiFi, universal serial bus (USB), and the like.

A presentation module 453 is configured to enable presentation of information via one or more output apparatuses 431 (for example, a display and a speaker) associated with the user interface 430 (for example, a user interface for operating a peripheral device and displaying content and information).

An input processing module 454 is configured to detect one or more user inputs or interactions from one of one or more input apparatuses 432 and translate the detected inputs or interactions.

In some embodiments, the apparatus provided in this embodiment of this application may be implemented by software. FIG. 2A shows a robot control apparatus 455 stored in a memory 450, which may be software in a form of a program and a plug-in, and includes the following software modules: an obtaining module 4551 and a switching module 4552. The modules are logical and may be combined in different manners or further split based on to-be-implemented functions. The functions of the various modules are to be explained below.

Referring to FIG. 2B, FIG. 2B is a schematic structural diagram of a robot according to an embodiment of this application. The electronic device provided in this embodiment of this application may be disposed in the robot 100 in FIG. 1A or FIG. 1B, to implement autonomous control of the robot 100. The robot 100 includes: at least one processor 210, a memory 250, at least one network interface 220, and a user interface 230. Various assemblies in the robot 100 are coupled together by using a bus system 240. The bus system 240 is configured to implement connection and communication between the assemblies. In addition to a data bus, the bus system 240 further includes a power bus, a control bus, and a status signal bus. However, for clear description, various types of buses in FIG. 2B are marked as the bus system 240.

The processor 210 may be an integrated circuit chip, and has a signal processing capability, for example, a general-purpose processor, a digital signal processor (DSP), another programmable logic device, a discrete gate or transistor logic device, or a discrete hardware component. The general-purpose processor may be a microprocessor or any conventional processor.

The user interface 230 includes one or more output apparatuses 231 that enable presentation of media content, including one or more speakers and/or one or more visual display screens. The user interface 230 further includes one or more input apparatuses 232, including a user interface component helping a user input, for example, a microphone, a touchscreen, a camera, and another input button and control.

The memory 250 may be a removable memory, a non-removable memory, or a combination thereof. Exemplary hardware devices include a solid-state memory, a hard disk drive, an optical disk drive, and the like. In some embodiments, the memory 250 includes one or more storage devices that are physically away from the processor 210.

The memory 250 includes a volatile memory or a non-volatile memory, or may include both a volatile memory and a non-volatile memory. The non-volatile memory may be a read-only memory (ROM), and the volatile memory may be a random-access memory (RAM). The memory 250 described in the embodiments of this application is to include any suitable type of memories.

In some embodiments, the memory 250 can store data to support various operations. Examples of the data include a program, a module, and a data structure, or a subset or a superset thereof, which are exemplarily described below.

An operating system 251 includes system programs for processing various basic system services and performing hardware-related tasks, for example, a framework layer, a kernel library layer, and a driver layer for implementing various basic services and process hardware-based tasks.

A network communication module 252 is configured to reach other electronic devices via one or more (wired or wireless) network interfaces 220. For example, the network interface 220 includes Bluetooth, WiFi, universal serial bus (USB), and the like.

A presentation module 253 is configured to enable presentation of information via one or more output apparatuses 231 (for example, a display and a speaker) associated with the user interface 230 (for example, a user interface for operating a peripheral device and displaying content and information).

An input processing module 254 is configured to detect one or more user inputs or interactions from one of one or more input apparatuses 232 and translate the detected inputs or interactions.

In some embodiments, the apparatus provided in this embodiment of this application may be implemented by software. FIG. 2B shows a robot control apparatus 255 stored in a memory 250, which may be software in a form of a program and a plug-in, and includes the following software modules: an obtaining module 2551 and a switching module 2552. The modules are logical and may be combined in different manners or further split based on to-be-implemented functions. The functions of the various modules are to be explained below.

In some other embodiments, the robot control apparatus provided in this embodiment of this application may be implemented by using hardware. For example, the robot control apparatus provided in this embodiment of this application may be a processor in the form of a hardware decoding processor, programmed to perform the robot control method provided in this embodiment of this application. For example, the processor in the form of a hardware decoding processor may use one or more application specific integrated circuits (ASICs), a DSP, a programmable logic device (PLD), a complex programmable logic device (CPLD), a field-programmable gate array (FPGA), or other electronic elements.

The robot and the robot control method provided in the embodiments of this application will be described in conjunction with the exemplary applications and implementations of the terminal device provided in the embodiment of this application.

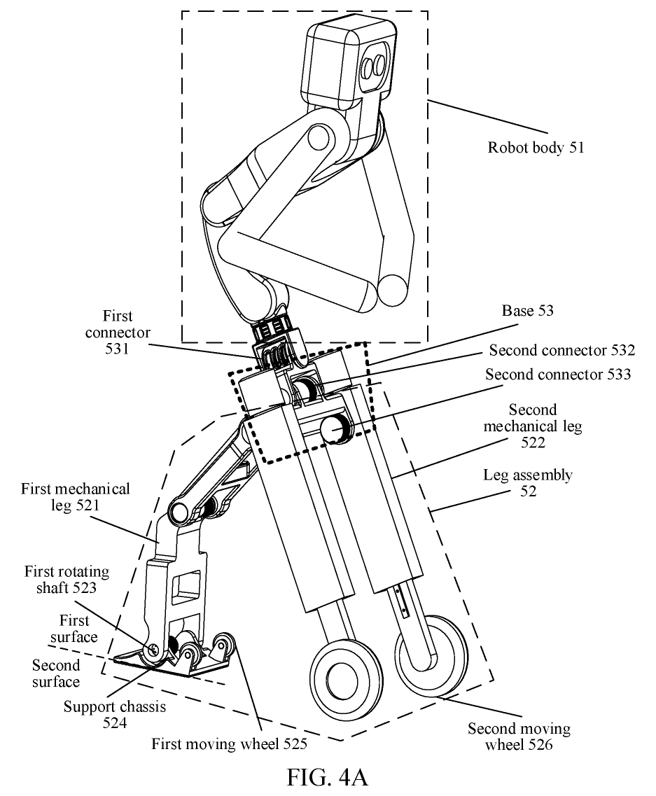

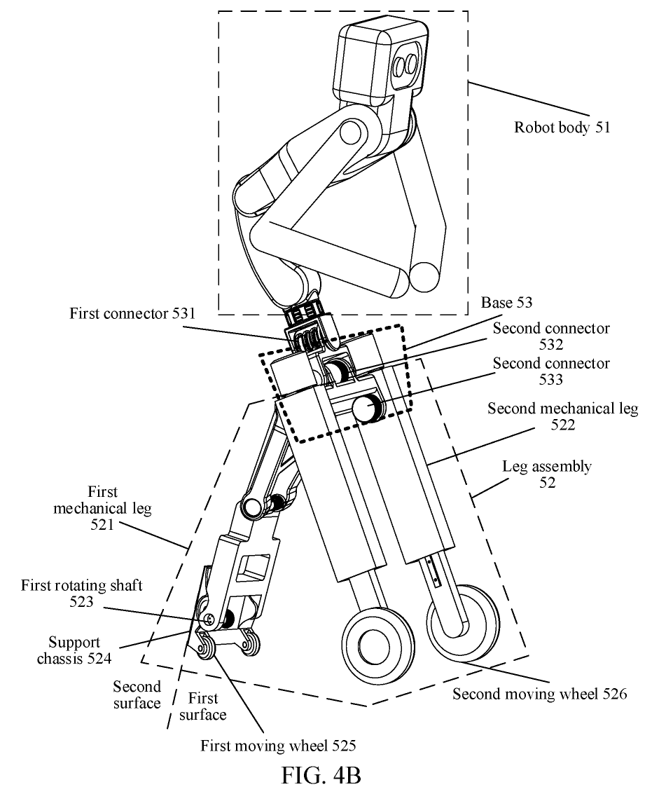

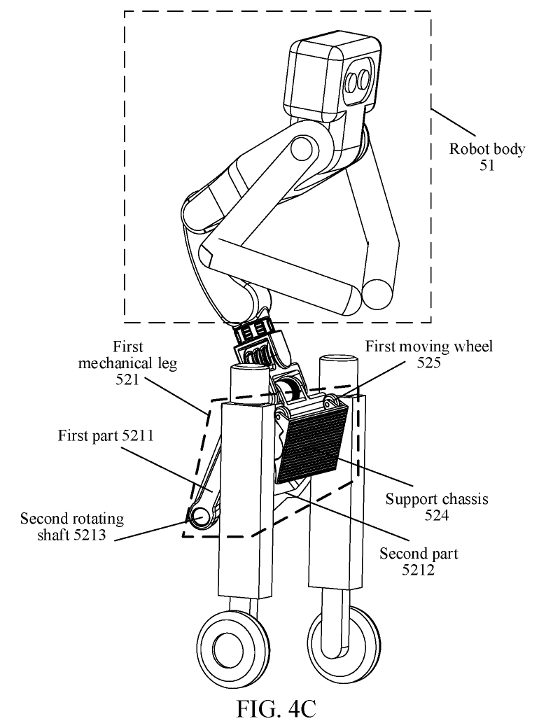

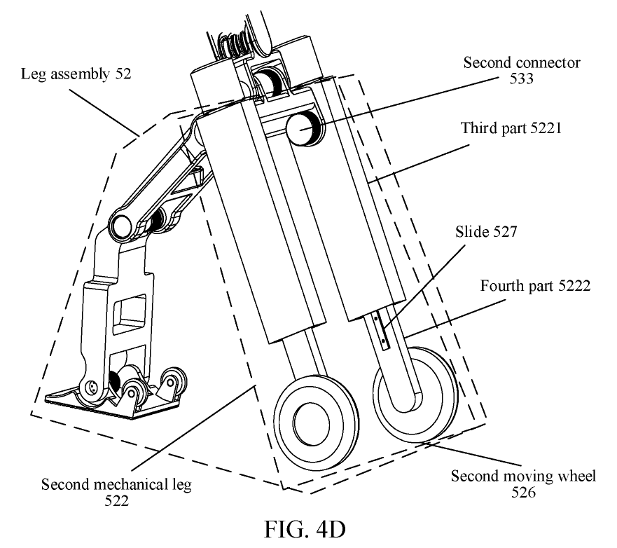

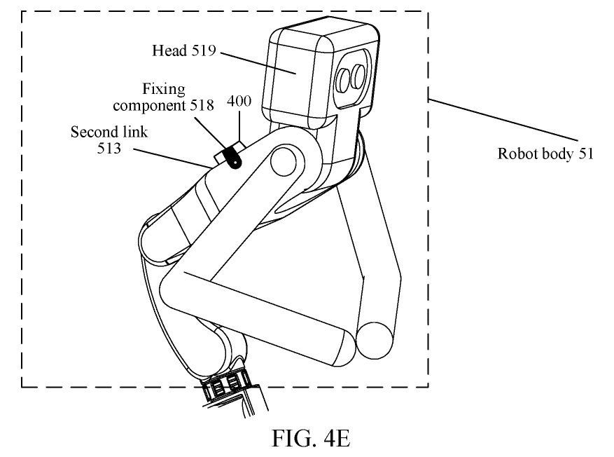

An embodiment of this application provides a robot. Referring to FIG. 4A, FIG. 4A is a schematic structural diagram of a robot according to an embodiment of this application. FIG. 4A shows the structure of the robot 100 in FIG. 1A or FIG. 1B.

Referring to FIG. 4A, FIG. 4A is a schematic structural diagram of a robot according to an embodiment of this application. The robot includes: a base 53, a robot body 51, and a leg assembly 52.

One end of the robot body 51 is connected to the base 53 by using a first connector 531. The leg assembly 52 includes a plurality of mechanical legs, and one end of each of the mechanical legs is connected to the base by using different second connectors. For example, the base 53 is connected to the first mechanical leg 521 by using a second connector 532, and the base 53 is connected to the second mechanical leg 522 by using a second connector 533.

For example, the robot body may be bionic, for example, made into a human form or an animal form. In this embodiment of this application, a human is imitated as an example for description. The first connector may be a ball joint. A ball joint is a mechanical connection apparatus that allows two connected components to rotate or swing in one or more directions. The ball joint usually includes a ball and a socket, and the ball may freely rotate in the socket, thereby implementing angle adjustment and motion within a particular range. The base is configured as a structure that connect a component (leg assembly) of the robot configured for moving and a component (robot body) configured to execute an operation corresponding to an application scenario.

For example, the mechanical legs are configured to support the robot to move. The second connector may be a revolute joint, for example, a rotating shaft. A specific quantity of the mechanical legs may be set according to an actual application scenario of the robot, for example, three, four, or more. In this embodiment of this application, an example in which there are three mechanical legs is used for description. The three mechanical legs include: two second mechanical legs and one first mechanical leg.

Still referring to FIG. 4A, a first rotating shaft 523 is disposed on an end of a first mechanical leg 521 of the plurality of mechanical legs away from the robot body. The first rotating shaft 523 is configured to connect a support chassis 524. First moving wheels 525 are disposed on a first surface of the support chassis 524. The first rotating shaft 523 is configured to rotate to form a first relative position and a second relative position with respect to the first mechanical leg 521.

For ease of understanding the connection manners, referring to FIG. 9A and FIG. 9B, FIG. 9A and FIG. 9B are schematic diagrams of a connector according to an embodiment of this application. FIG. 9A and FIG. 9B are side views of a link 903 in different directions. In FIG. 9A, a link 901 and the link 903 are connected by using a rotating shaft 902, and the rotating shaft 902 is a connector. A side of the link 901 that is configured to connect the link 903 is configured as two ends of a fork shape, so as to cover the end of the link 903 that is configured to connect the link 901. In FIG. 9B, a center of an end of the link 903 that is configured to connect to the link 901 is a circular hole 9031, and the circular hole 9031 enables the rotating shaft 902 to pass through the link 903. Through connection of the rotating shaft 902, the link 901 and the link 903 can rotate about the rotating shaft 902. Connection manners in FIG. 9A and FIG. 9B correspond to the first connector among the first rotating shaft, the first mechanical leg, and the base.

In the first relative position, the first moving wheels and the first rotating shaft are located on the first surface of the support chassis, and the first moving wheels are configured to contact a support surface. Referring to FIG. 4B, FIG. 4B is a schematic structural diagram of a robot according to an embodiment of this application. FIG. 4B shows a form in which the robot in FIG. 4A presents the first relative position.

In FIG. 4B, a bracket is disposed on the first surface of the support chassis 524, and the bracket is configured to provide the rotating shaft of the first moving wheels 525. In the first relative position, the first surface or a second surface of the support chassis 524 is parallel to at least a part of the first mechanical leg. The first surface of the support chassis 524 faces a forward direction of the robot, and the second surface faces a direction opposite to the forward direction of the robot.

In some embodiments, in the first relative position, the support chassis and the first mechanical leg may be in a snap fit to form the first relative position. The snap fit refers to the form of fixing two objects together by using structures such as a groove and a protrusion between the objects. For example, a part of the support chassis that is configured to be in a snap fit with the first mechanical leg may be provided with a protrusion, and a part of the first mechanical leg that is in a snap fit with the support chassis is provided with a groove.

Alternatively, a driving motor of the robot drives the first rotating shaft to a fixed angle, to form the first relative position. For example, by means of rotation of the first rotating shaft, a preset acute angle (a value of the preset angle is set based on an actual application scenario) is formed between a plane of the support chassis and the link of the first mechanical leg, and the center of the first moving wheels of the support chassis and the link of the first mechanical leg are on the same straight line.

In some embodiments, in addition to the disposition manner in FIG. 4B, the first moving wheels may alternatively be fixed to the support chassis by using nuts, and the first moving wheels may be driven castor wheels.

In the second relative position, the second surface of the support chassis is configured to contact the support surface (for example, the ground). Still referring to FIG. 4A, FIG. 4A shows the first mechanical leg in the second relative position. The second surface of the support chassis 524 is in contact with the support surface, and the second surface is in a direction opposite to the support surface.

In this embodiment of this application, an end of the first mechanical leg is provided as the support chassis and the moving wheels, and the end of the first mechanical leg can be switched between a mode in which the support chassis is in contact with the support surface and a mode in which the moving wheels are in contact with the support surface, thereby enriching locomotion manners of the robot and improving stability of the robot during movement.

In some embodiments, the second surface of the support chassis is configured to contact the support surface, and any one of the following structures is disposed on the second surface of the support chassis:

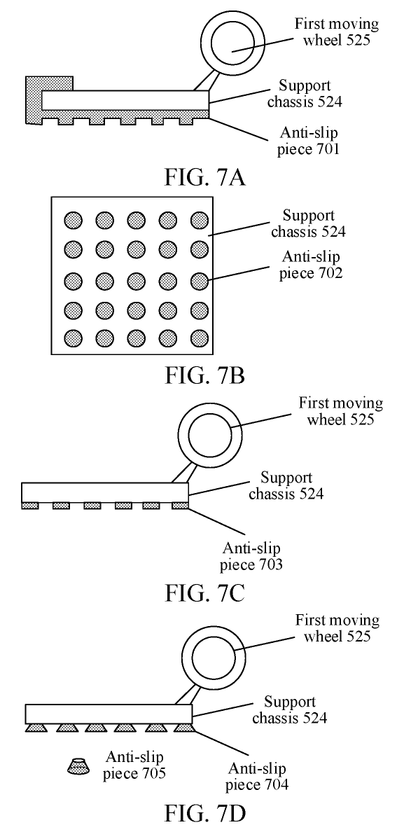

1. A detachable anti-slip piece is disposed on the second surface. For example, a material of the detachable anti-slip piece may be rubber or plastic. Referring to FIG. 7A, FIG. 7A is a first schematic structural diagram of a support chassis of a robot according to an embodiment of this application. FIG. 7A is a side view of the support chassis 524. An anti-slip piece 701 is disposed on the second surface of the support chassis 524. The anti-slip piece 701 is in a snap fit with the support chassis 524, and the anti-slip piece 701 may be detached from the support chassis 524. A side of the anti-slip piece 701 that is configured to be in contact with the support surface is provided with an anti-slip structure. The anti-slip structure may be a structure in which a surface is provided with grooves or protrusions. The foregoing structure can increase a friction force with the support surface.

In this embodiment of this application, by providing the detachable anti-slip piece, on one hand, the friction force between the robot and the ground can be increased, and the stability of the robot can be improved; and on the other hand, the detachable anti-slip piece facilitates replacement and maintenance of components of the robot.

2. A plurality of groove components are dispersedly disposed on the second surface. For example, the groove components may be in a form of dots, stripes, or textures. Assuming that the support chassis is made of metal, the second surface may be provided as groove components formed by a rubber coating applied over the metal. Alternatively, the support chassis is cast as a metal component having grooves. Referring to FIG. 7B, FIG. 7B is a second schematic structural diagram of a support chassis of a robot according to an embodiment of this application. FIG. 7B is a top view of a second surface of a support chassis 524. A plurality of anti-slip pieces 702 (this part is represented as recesses by using dashed areas) are disposed on the second surface. The anti-slip pieces 702 are dotted groove components, and the anti-slip pieces 702 are regularly arranged to increase the friction force between the second surface and the support surface.

3. A plurality of protrusion components are dispersedly disposed on the second surface. For example, the protrusion components may be in a form of dots, stripes, or textures. Assuming that the support chassis is made of metal, the second surface may be provided as protrusion components formed by a rubber coating applied over the metal. Alternatively, the support chassis is cast as a metal component having protrusions. Referring to FIG. 7C, FIG. 7C is a third schematic structural diagram of a support chassis of a robot according to an embodiment of this application. FIG. 7C is a side view of a support chassis 524. A plurality of anti-slip pieces 703 are disposed on the second surface of the support chassis 524. The anti-slip pieces 703 are protrusion components, and the anti-slip pieces 703 are strip-shaped.

For example, the protrusion component may alternatively be a vacuum suction cup, and the vacuum suction cup (also referred to as a vacuum gripper or a vacuum nozzle) is one of vacuum device actuators. The vacuum suction cup implements holding and carrying of an object by creating a negative pressure in a vacuum chamber to make the attachment generate an attachment force and cling to a smooth surface. Referring to FIG. 7D, FIG. 7D is a fourth schematic structural diagram of a support chassis of a robot according to an embodiment of this application. A plurality of anti-slip pieces 704 are disposed on the second surface of the support chassis 524. The anti-slip pieces 704 are vacuum suction cups, and an anti-slip component 705 is a three-dimensional view of the anti-slip piece 704. The anti-slip component 705 may be a bowl-shaped component made of rubber that has two circular ends. The end of the bowl-shaped component that has a large circle is configured to contact the support surface, and a bottom of the bowl-shaped component is configured to be fixed on the support chassis.

In this embodiment of this application, the protruding anti-slip pieces or the recessed anti-slip pieces are disposed on the support chassis of the robot, so that the anti-slip pieces can adapt to different types of grounds, such as rough, smooth, and bumpy grounds, thereby increasing adaptability and reliability of the robot in a complex environment. By disposing the suction cups on the support chassis of the robot, the suction cups can be securely attached to the ground or another surface, so that the friction force between the robot and the ground is increased, thereby improving stability of the robot during operation, and especially on an uneven or smooth surface, the robot can maintain good contact and stability on different grounds, to adapt to various complex environments.

In some embodiments, the support chassis may have both grooves and protrusions. For example, in FIG. 7A and FIG. 7C, the grooves and the protrusions are relative to each other.

In this embodiment of this application, the second surface (the surface configured to contact the support surface) of the support chassis is provided as a rough and anti-slip surface, thereby improving the friction force between the support chassis and the support surface and improving the stability of the robot.

In some embodiments, the first mechanical leg includes a first part and a second part. The first part is connected to the base by using the second connector, and the first rotating shaft is disposed on an end of the second part away from the robot body. The first part is connected to the second part by using a second rotating shaft, and the second rotating shaft is configured to rotate so that a third relative position and a fourth relative position are formed between the first part and the second part.

In the third relative position, the second part is configured to support the first part.

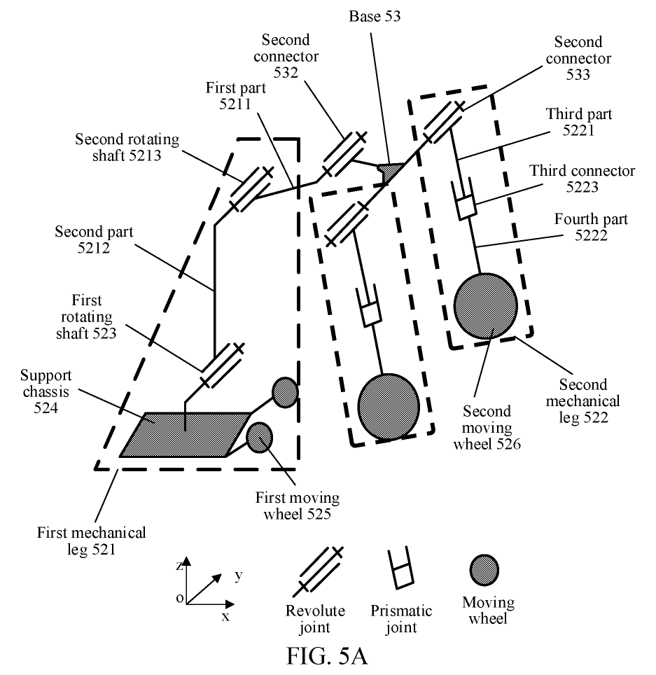

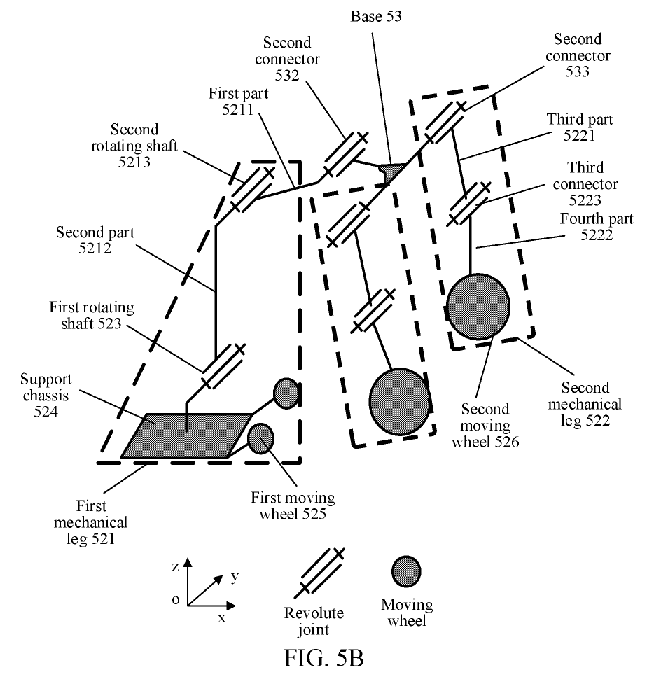

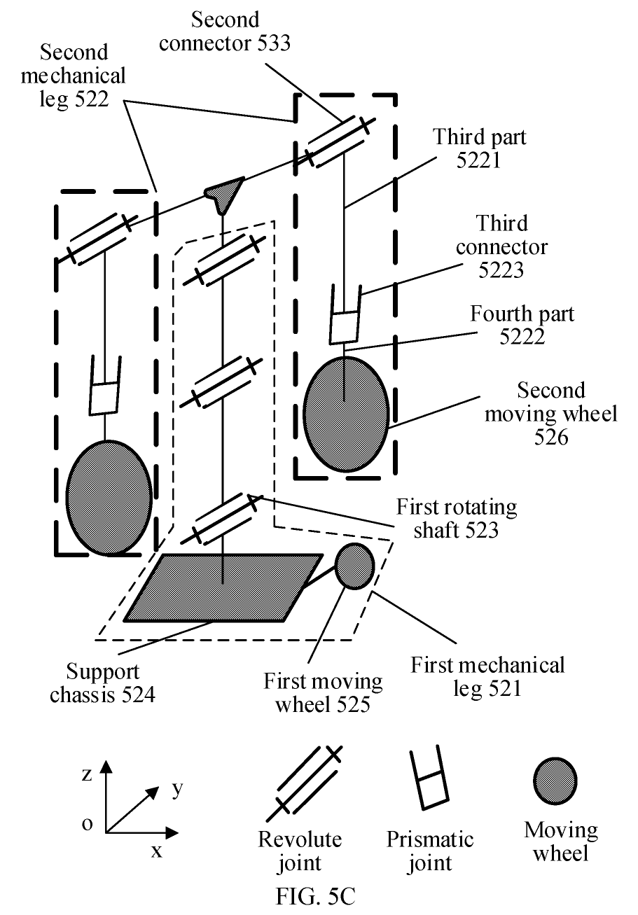

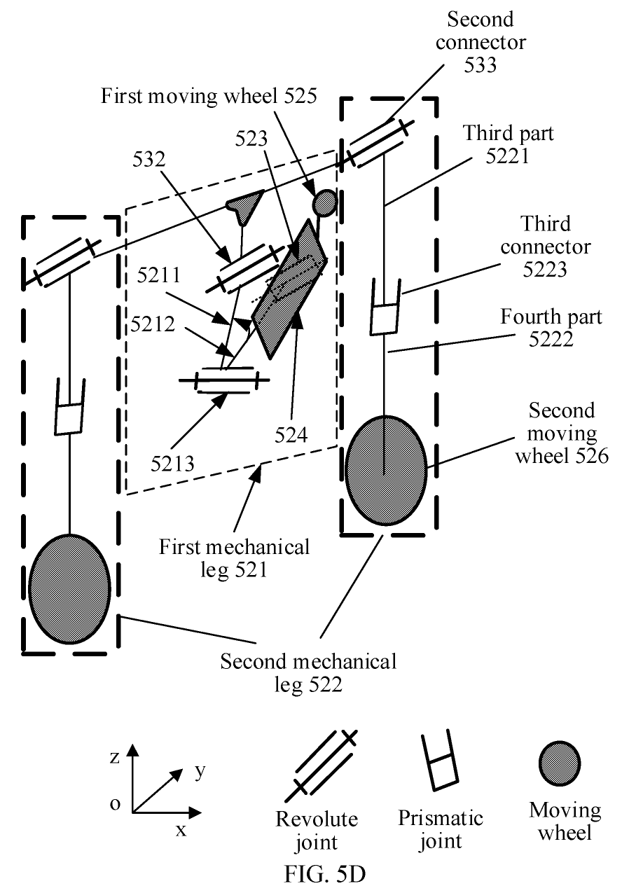

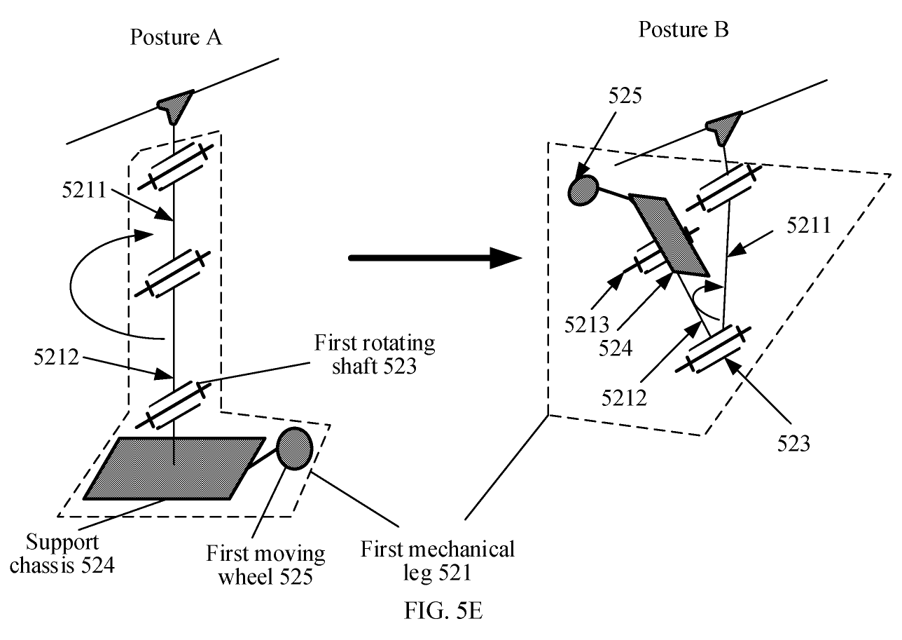

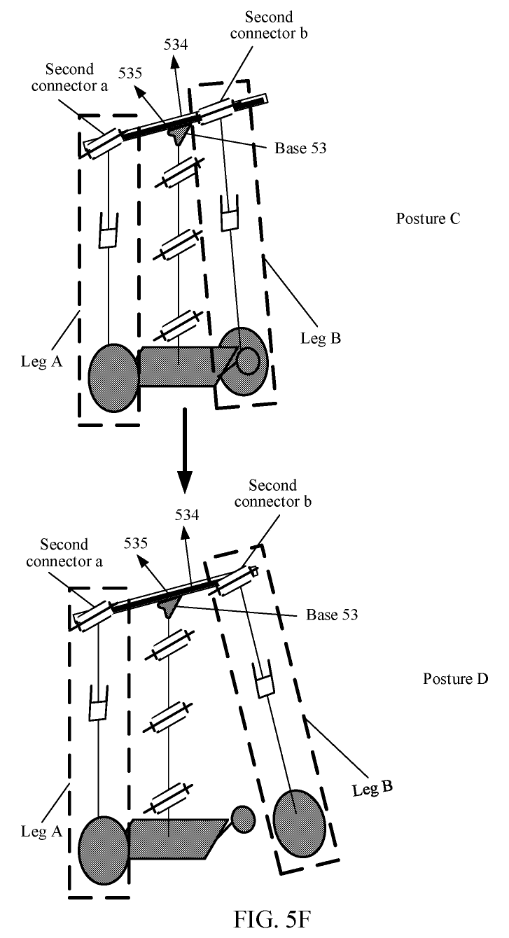

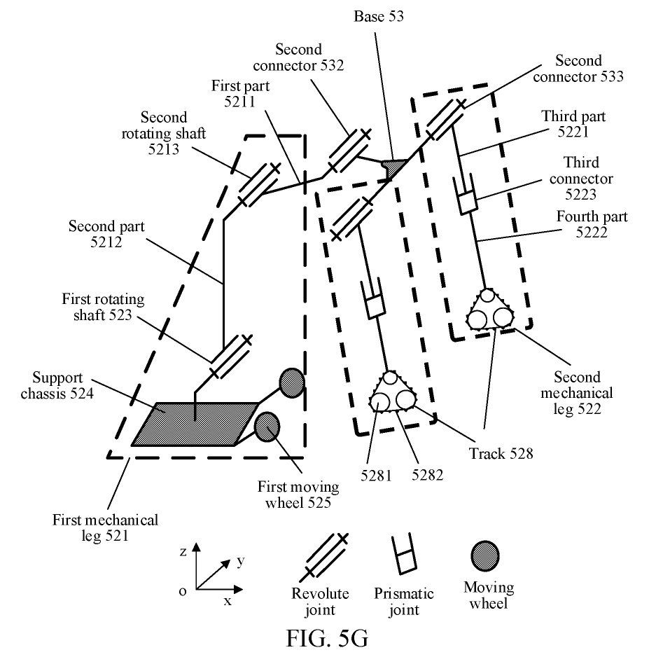

For example, the third relative position is presented during the movement of the robot supported by the first mechanical leg. The first part and the second part may be links. For ease of understanding, referring to FIG. 5A, FIG. 5A is a first schematic structural diagram of a base and a leg assembly of a robot according to an embodiment of this application. FIG. 5A is a simplified structural diagram of FIG. 4A. In FIG. 5A, the first mechanical leg is presented in the third relative position. The first mechanical leg includes a first part 5211 and a second part 5212. The first part 5211 is connected to the second part 5212 by using a second rotating shaft 5213. The second part 5212 is connected to the first surface of the support chassis 524 by using a first rotating shaft 523. The second surface of the support chassis 524 is a plane, and an angle formed between the second part and the first part is a non-acute angle. Therefore, the second part supports the first part.

In the fourth relative position, the angle formed between the second part and the first part is an acute angle, and the first moving wheels or the second surface of the support chassis is not in contact with the support surface.

For example, the fourth relative position is presented when the first mechanical leg is folded. Referring to FIG. 4C, FIG. 4C is a schematic structural diagram of a robot according to an embodiment of this application. FIG. 4C shows a form in which the first mechanical leg of the robot in FIG. 4A or FIG. 4B is folded. In FIG. 4C, the first mechanical leg is presented in the fourth relative position. The first part 5211 is connected to the second part 5212 by using the second rotating shaft 5213, and the second rotating shaft 5213 rotates, so that an acute angle is formed between the first part 5211 and the second part 5212.

FIG. 4C shows a view in which the first mechanical leg is folded toward the forward direction of the robot. In an actual application scenario, if there is no obstacle affecting motion of the robot in the environment of the robot, the first mechanical leg of the robot may also be folded in the direction opposite to the forward direction.

For ease of understanding, the following explanation will be made in combination with simplified schematic diagrams. Referring to FIG. 5D and FIG. 5E, FIG. 5D to FIG. 5E are schematic diagrams of a first mechanical leg of a robot in a fourth relative position according to an embodiment of this application.

In FIG. 5D, the second part 5212 moves toward the first part 5211 in a counterclockwise direction, the second rotating shaft 5213 rotates such that the second part 5212 and the first part 5211 form a folded form, and by rotation of the first rotating shaft 523, an acute angle is formed between the support chassis 524 and the second part 5212, i.e., the support chassis 524 and the second part 5212 also present a folded form. A folding manner in FIG. 5D is the same as that in FIG. 4C.

In FIG. 5E, posture A is an upright posture of the first mechanical leg 521, and posture B is a folded posture of the first mechanical leg 521, with a folding direction opposite to that in FIG. 5D. In posture A, the second part 5212 moves toward the first part 5211 in a clockwise direction, and by rotation of the first rotating shaft 523, an acute angle is formed between the support chassis 524 and the second part 5212, such that the support chassis and the second part are folded in the direction opposite to the forward direction of the robot, which is opposite to the folding manner in FIG. 5D.

In this embodiment of this application, the first mechanical leg may be in a bent or folded form. When the first mechanical leg is in the folded form, the ground area occupied by the robot is reduced, so that the robot can be applicable to more application scenarios, thereby improving the universality of the robot.

In some embodiments, a second mechanical leg of the plurality of mechanical legs includes a third part and a fourth part. One end of the third part is connected to the base by using the second connector corresponding to the second mechanical leg, and the other end of the third part is connected to the fourth part by using a third connector.

For example, the second connector may be a revolute joint. Referring to FIG. 9C, FIG. 9C is a third schematic diagram of a connector according to an embodiment of this application. FIG. 9C is a side view of the connector, applicable to the second connector corresponding to the second mechanical leg. A link 904 is connected to a link 906 by using a rotating shaft 905. The link 904 may be disposed on the base, and the link 906 may be a link of the second mechanical leg. A circular hole is provided in a part, configured to connect another component, of each of the link 904 and the link 906. The rotating shaft 905 may pass through the circular holes to connect the two links, and the two links can rotate about the rotating shaft 905.

For example, for ease of understanding, still referring to FIG. 5A, the second mechanical leg 522 includes a second moving wheel 526, a third part 5221, a fourth part 5222, and a third connector 5223. The third part 5221 and the fourth part 5222 are connected by using the third connector 5223.

In some embodiments, the second moving wheel is disposed on one end of the robot body in the fourth part, and the second moving wheel is configured to contact the support surface. For example, the second moving wheel is a driving wheel, and is driven by the driving motor of the robot. Still referring to FIG. 5A, the second moving wheel 526 may be a driving wheel.

In this embodiment of this application, the end of the second mechanical leg is provided with the moving wheel, so that flexibility of the second mechanical leg during movement is improved, and when the second moving wheel is a driving moving wheel, the motion speed of the robot can further be improved.

In some embodiments, a track is disposed on one end of the robot body in the fourth part, and the track is configured to contact the support surface. For example, if the track is disposed on the end away from the robot body, the track includes a driving wheel and a flexible chain. Referring to FIG. 5G, FIG. 5G is a fourth schematic structural diagram of a base and a leg assembly of a robot according to an embodiment of this application. In the fourth part 5222 of the second mechanical leg 522, a track 528 is disposed on one end of the robot body, and the track 528 includes a driving wheel 5281 and a flexible chain wrapping the driving wheel 5281.

In this embodiment of this application, the end of the second mechanical leg is provided with the track, so that a supporting area between the robot and the support surface is increased, thereby improving the stability of locomotion of the robot on the support surface and allowing the robot to keep a balanced state.

In some embodiments, the third connector is a slide rail. The fourth part is configured to slide parallel to the third part based on the slide rail.

For example, still referring to FIG. 5A, in FIG. 5A, an example in which the third connector is a prismatic joint is used for description. When the third connector is a prismatic joint, the second mechanical leg 522 in FIG. 5A is a prismatic driver leg. The fourth part 5222 slides on the third part 5221 based on the prismatic joint, and during the sliding, the fourth part 5222 is parallel to the third part 5221. The prismatic joint is an element such as a slide rail. The fourth part 5222 is sleeved inside the third part 5221, and the slide rail may be disposed in a gap between the fourth part 5222 and the third part 5221.

For ease of explanation and description, referring to FIG. 4D, FIG. 4D is a schematic structural diagram of a robot according to an embodiment of this application. FIG. 4D is a detailed structural diagram corresponding to FIG. 5A. The slide rail is briefly referred to as a slide. The slide 527 is disposed inside the third part 5221, and the third part 5221 is sleeved over the fourth part 5222, so that the slide 527 is located in a gap between the fourth part 5222 and the third part 5221.

In this embodiment of this application, the slide is disposed between the third part and the fourth part of the second mechanical leg, so that the second mechanical leg can extend and retract, thereby improving the mobility of the robot, and further enabling the robot to adapt to more different environments.

In some embodiments, the third connector is a third rotating shaft. The fourth part is configured to rotate, based on the third rotating shaft, about an end of the third part away from the robot body. Referring to FIG. 5B, FIG. 5B is a first schematic structural diagram of a base and a leg assembly of a robot according to an embodiment of this application. In FIG. 5B, the third connector in a form of a slide rail in FIG. 5A is replaced with a revolute joint, and the revolute joint may be a third rotating shaft.

In some embodiments, the third connector is configured to rotate or slide, so that the fourth part forms a fifth relative position relative to the first mechanical leg. In the fifth relative position, the second surface of the support chassis of the first mechanical leg is configured to contact the support surface, and the second moving wheel of the fourth part is not in contact with the support surface.

For example, in this embodiment of this application, an example in which the mechanical legs include the first mechanical leg and the second mechanical leg is used for description. When the second moving wheel of the fourth part is not in contact with the support surface, the robot is in contact with the support surface only by the support chassis. Referring to FIG. 5C, FIG. 5C is a schematic diagram of a first mechanical leg of a robot in a fifth relative position according to an embodiment of this application. When the third connector 5223 is a prismatic joint, the third part 5221 and the fourth part 5222 of the second mechanical leg 522 may slide relative to each other, so that the second mechanical leg 522 may extend and retract in length. When the second mechanical leg 522 retracts, the support chassis 524 of the first mechanical leg is configured to contact the support surface, so as to form a posture in which the robot is in contact with the support surface only by the support chassis, as shown in FIG. 5C.

In this embodiment of this application, when the second mechanical leg retracts, the robot only uses the first mechanical leg as the support, which can reduce the ground area occupied by the robot. The mechanical legs of the robot may perform different motion manners such as folding, and extension and retraction, so that the robot has more postures and can be applicable to different application scenarios.

In some embodiments, when there are a plurality of second mechanical legs, the second connectors respectively corresponding to the plurality of second mechanical legs and the first mechanical leg are dispersedly disposed on the base.

For example, the second connectors of the mechanical legs are dispersedly disposed on the base, so that the plurality of mechanical legs are evenly distributed, and the robot body can be stable and balanced (for example, in FIG. 4A, the mechanical legs are evenly arranged). Because both the first mechanical leg and the second mechanical leg are connected to the base by using the convertible connectors, during movement, an included angle between the first mechanical leg and the second mechanical leg is adjustable. A larger angle between the first mechanical leg and the second mechanical leg indicates a lower center of gravity of the robot body, and vice versa. The included angle may be dynamically adjusted according to the load of the robot, so that the center of gravity is not higher than a height threshold, thereby preventing the robot from falling over due to the excessively high center of gravity, and ensuring the stability of movement. Alternatively, when the center of gravity of the robot is not stable (for example, the speed at which the center of gravity moves in a certain direction is greater than a speed threshold), the first surface of the support chassis of the first mechanical leg is switched to the second surface, thereby increasing the supporting area between the robot and the support surface and improving the stability.

In some embodiments, when a quantity of the second mechanical legs is an even number, the second connectors of the plurality of second mechanical legs are disposed on the base around the second connector of the first mechanical leg.

For example, the second connectors of the plurality of second mechanical legs being disposed on the base around the second connector of the first mechanical leg means that the second connectors of the plurality of second mechanical legs are evenly distributed on the base by using the second connector of the first mechanical leg as the center. For ease of explanation and description, referring to FIG. 4A, the quantity of the second mechanical legs 522 is an even number, which is two, and the second connectors 533 of the two second mechanical legs 522 are disposed by using the first mechanical leg 521 as the center of symmetry, so that weights of two sides of the robot are balanced, thereby improving the balance of the robot.

In this embodiment of this application, by means of the foregoing arrangement manner, the first mechanical leg is located at the position of the center of gravity of the robot, and in the process in which the first rotating shaft of the first mechanical leg switches between the first relative position and the second relative position, the second mechanical legs of the robot can provide more stable support, thereby improving the stability of the robot and reducing the probability that the robot loses balance and falls over.

In some embodiments, the second connectors respectively corresponding to the plurality of second mechanical legs are disposed in the slide rail on the base, and the second connector corresponding to any of the second mechanical legs is configured to, when moving on the slide rail, change a distance from the adjacent second mechanical leg.

The second connectors of the second mechanical legs are disposed in the slide rail on the base, that is, the distance between the second mechanical legs is flexible. The slide rail has limiting structures, to prevent the second connector from exceeding the length range of the slide rail and derailing. For example, the limiting structures are fixed on two ends of the slide rail by using screws and nuts, or mortise and tenon structures. For another example, the second connector of the second mechanical leg has a preset sliding range, and the limiting structures of the slide rail may be baffles that are respectively disposed on two ends of the preset sliding range of the slide rail. Alternatively, a contact area between the slide rail and the second connector has a damping coefficient (using a damping material) of movement, so that the second connector can be fixed at a current position.

For ease of understanding, referring to FIG. 5F, FIG. 5F is a third schematic structural diagram of a base and a leg assembly of a robot according to an embodiment of this application. The second mechanical legs of the robot include a leg A and a leg b. The leg A is connected to the base by using a second connector a, and the leg b is connected to the base by using a second connector b. The base is provided with a link 534 and a slide 535 (dark-colored part). The slide 535 (dark-colored part) is fixed to the link 534, and the second connector a and the second connector b are disposed on the slide. Limiting baffles are respectively provided at ends of the slide 535. In posture C, the second connector b of the leg b is located in a slidable range of the slide 535. By sliding, the distance between the leg A and the leg b is changed, the posture of the leg assembly of the robot is changed to posture D, and the second connector b of the leg b in posture D is located at the end of the slide 535.

In some embodiments, a combination of the first moving wheels of the first mechanical leg and the second moving wheels of the second mechanical legs includes the following types:

Type 1: The first moving wheels are driven wheels, and the second moving wheels are driving wheels. For example, the first moving wheels may be driven castor wheels, and the second moving wheels may be driving wheels driven by a motor. A driven wheel is a wheel that lacks its own driving force and is driven by another apparatus, and a driving wheel is a wheel driven by a motor. A castor wheel is a wheel that can freely rotate in a horizontal plane, and a main feature of the castor wheel is that the castor wheel can freely rotate about a fixed shaft, so that an object connected to the castor wheel can conveniently change the direction. A castor wheel usually includes a wheel and a bearing connected to the wheel. The bearing allows the wheel to freely rotate about a shaft.

Type 2: The first moving wheels are driving wheels, and the second moving wheels are driving wheels. For example, the first moving wheels may be driving wheels driven by a motor and the second moving wheels are all driving wheels driven by a motor. When the first moving wheels and the second moving wheels are all used as parts in contact with the support surface, driving forces respectively corresponding to the first moving wheels and the second moving wheels are determined according to a current motion environment of the robot.

In this embodiment of this application, when the first moving wheels are set as driven wheels, electric energy required for driving the first moving wheels can be saved. When the first moving wheels and the second moving wheels are all set as driving wheels, the plurality of driving wheels can reduce slipping on wet or unstable ground, thereby improving traction of the robot and improving the stability and motion efficiency of the robot.

In some embodiments, the robot body includes a torso and at least one mechanical arm, and one end of each of the mechanical arms is connected to the torso by using different fifth connectors. The fifth connector may be a ball joint, for example, a spherical bearing.

In some embodiments, the torso includes at least one link. When there are a plurality of links, each link is successively connected, every two adjacent links are connected by using a fourth rotating shaft, a quantity of the fourth rotating shafts is less than a quantity of the links, and one end of the link in the plurality of links closest to the base is connected to the base by using the first connector.

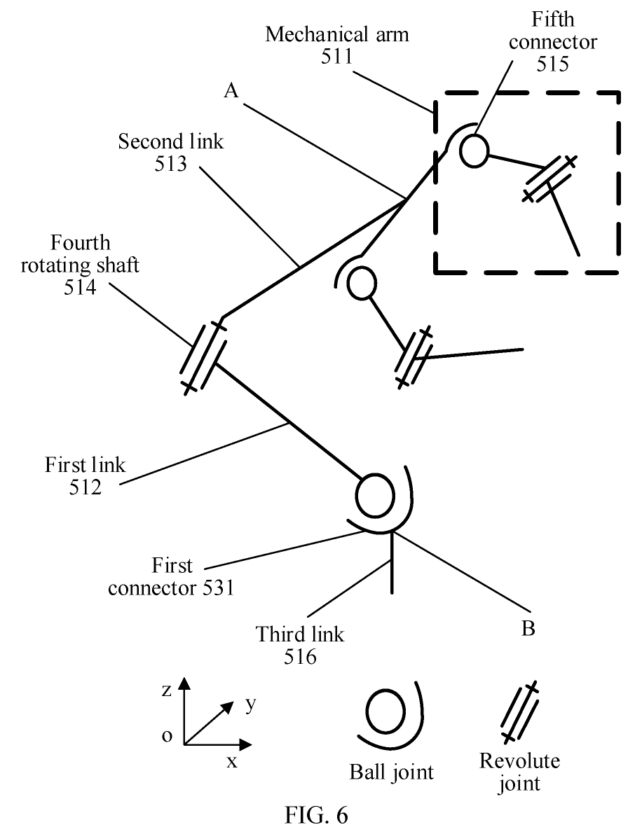

Referring to FIG. 6, FIG. 6 is a second schematic structural diagram of a robot body of a robot according to an embodiment of this application. FIG. 6 is a simplified structural diagram of the robot body 51 in FIG. 4A to FIG. 4C and FIG. 4E.

The robot body includes a first link 512, a second link 513, a third link 516, and a plurality of mechanical arms 511. In this embodiment of this application, an example in which there are two mechanical arms 511 is used for description. According to a specific application scenario, structures of the two mechanical arms may be different or the same, and the two mechanical arms are respectively disposed on opposite sides of the first link 512. The mechanical arms 511 are connected to an end of the second link 513 away from the base of the robot by using fifth connectors 515. The second link 513 is connected to the first link 512 by using a fourth rotating shaft 514. An end of the first link 512 close to the base of the robot is connected to the base by using a first connector 531. The fifth connector 515 may be a ball joint. The first connector 531 may be a ball joint, for example, a spherical bearing. The mechanical arms 511 may be provided with structures such as a revolute joint or a mechanical hand, thereby allowing the robot to perform different operations.

In some embodiments, when there are a plurality of links and a plurality of mechanical arms, a connection relationship between the links and the mechanical arms is any one of the following cases:

Type 1: The link is connected to the plurality of mechanical arms by using the different fifth connectors. Referring to FIG. 6, two sides of the first link 512 are respectively connected to different mechanical arms 511.

Type 2: The link is not connected to any mechanical arm. Still referring to FIG. 6, two sides of the second link 513 are not connected to any mechanical arm.

Type 3: The link is connected to one of the mechanical arms by using the fifth connector.

In this embodiment of this application, the mechanical arms are disposed at different parts of the robot body. Distribution of the mechanical arms can enhance stability of the robot. The plurality of mechanical arms are configured to keep balance of the robot body, which can reduce wobble and overturning risks of the robot. Different tasks may need different types of mechanical arms. By disposing the plurality of mechanical arms on the robot, the robot can more easily adapt to different tasks.

In some embodiments, the robot body is connected to the base by using the first connector. Alternatively, still referring to FIG. 6, the robot body may be fixed to the base by using a link.

In this embodiment of this application, the body and the mechanical legs of the robot are connected by using the base, so that the mechanical legs and the body of the robot are independent of each other, thereby facilitating disassembly and maintenance of the robot. By disposing the plurality of mechanical legs on the robot, the robot can adapt to different environments, so as to keep balance of the robot body and improve movement efficiency of the robot. The first mechanical leg is disposed in the plurality of mechanical legs, and the first mechanical leg includes the support chassis and the moving wheels, which enables the robot to switch between different support manners, thereby improving stability of the robot in a complex environment and further improving working efficiency and movement efficiency of the robot.

The following describes a robot control method provided in an embodiment of this application. As described above, the robot control method in this embodiment of this application is implemented by an electronic device. The electronic device may be a terminal device or a server. The robot may be controlled either internally or externally. For example, an electronic device is disposed in the robot, and the robot performs autonomous control. Alternatively, the robot is externally controlled by using a server or a terminal device. When there is a fault in a communication connection between the external and the robot, the robot switches to the autonomous control mode. Therefore, the execution subject of each operation will not be repeatedly described below.

In the following examples, the robot is described by using an example in which the robot is the robot provided in this embodiment of this application. A person skilled in the art may apply, according to the following understanding, the robot control method provided in this embodiment of this application to processing of another robot including the first mechanical leg.

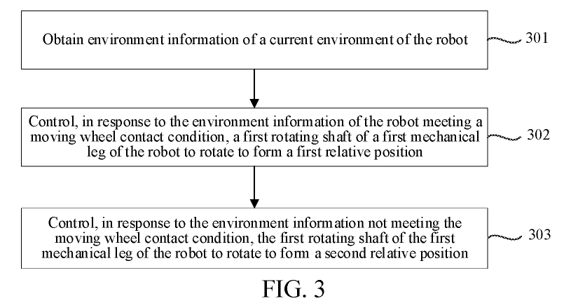

Referring to FIG. 3, FIG. 3 is a schematic flowchart of a robot control method according to an embodiment of this application, which will be described in combination with operations shown in FIG. 3 by using an electronic device as the execution subject.

Operation 301: Obtain environment information of a current environment of a robot.

The robot is provided with various functional modules, which include, but are not limited to, a photoelectric sensor, a camera, a microphone, an infrared sensor, a thermal imaging sensor, and the like. The robot can acquire environment information of an ambient environment by using the foregoing functional modules. For example, a sound signal of the ambient environment is acquired by using the microphone; distances between various parts of the robot and obstacles in the ambient environment are acquired by using the photoelectric sensor and the camera; and whether a human or an animal exists in the ambient environment is determined by using the thermal imaging sensor.

The robot further includes a network communication module. The network communication module is configured to reach another electronic device by using one or more (wired or wireless) network interfaces, so that the robot may communicate with the terminal device or the server.

When the electronic device is the terminal device 400 in FIG. 1A to FIG. 1B, the robot sends the environment information to the terminal device 400 by using the communication module. The robot may be directly connected to the terminal device 400 through a data line, Bluetooth, or a network. The terminal device 400 may be a mobile phone, a tablet computer, a notebook computer, a computer, or a remote control of a user.

The terminal device 400 may communicate with the robot 100 in a wired or wireless manner. For example, the remote control controls the robot through the wired connection, and the user controls the remote control, so that the robot executes related operations. When the robot and the mobile phone of the user are connected to the same WIFI, the user may wirelessly connect the mobile phone to the robot, and controls, by using the mobile phone, the robot to perform related operations.

When the electronic device is an electronic device carried in the robot, the robot may perform autonomous control.

In some embodiments, the robot simultaneously supports being controlled by a terminal device or being controlled by an electronic device carried in the robot. When the robot is not in communication connection with the terminal device, the robot is controlled by default by the electronic device carried in the robot, and when the robot is in communication connection with the terminal device, the robot is controlled by the terminal device. When the communication connection between the robot and the terminal device is faulty (for example, the wireless network is disconnected or the wired connection line is disconnected), the robot switches from being controlled by the terminal device to being controlled by the electronic device carried in the robot.

In some embodiments, the terminal device may be disposed inside a head of the robot in the body, or the robot is provided with a component for fixing the terminal device. For example, the terminal device is disposed on a side of the link of the robot used as the torso, and a snap-fit component is disposed on the second link to fix the terminal device onto the link of the robot.

Referring to FIG. 4E, FIG. 4E is a second schematic structural diagram of a robot body according to an embodiment of this application. In some cases, a terminal device is disposed in a head 519 of a robot body 51. Alternatively, a fixing component 518 is disposed on a side of the second link 513 of the robot away from the base. The fixing component 518 is configured to fix the terminal device 400. Assuming that the robot is a humanoid or animal-imitating robot, the fixing component 518 may be disposed on a back of the robot, that is, a side opposite to the forward direction, to prevent the terminal device for controlling the robot from being damaged due to falling forward during the movement of the robot.

Operation 302: Control, in response to the environment information of the environment of the robot meeting a first contact condition, a first rotating shaft of a first mechanical leg of the robot to rotate a support chassis to form a first relative position.

For example, the first contact condition includes the following content: a smoothness degree of the support surface of the environment of the robot can support rotation of a driven wheel; there is no obstacle that hinders the robot from switching from the second surface to the first surface within the surrounding range of the robot; and the current position of the center of gravity of the robot is within a safe range, and the robot is not in the first relative position. The safe range refers to a range in which the robot does not tip over.

For example, the terminal device may invoke a neural network model based on the environment information to perform classification. The classification results include that: the environment information meet the first contact condition, or the environment information does not meet the first contact condition. The neural network model configured for classification is trained based on a rotation record of the first rotating shaft of the robot. The rotation record includes: a rotation angle of the first rotating shaft, and sample environment information corresponding to the rotation angle.

Operation 303: Control, in response to the environment information not meeting the first contact condition, the first rotating shaft of the first mechanical leg of the robot to rotate the support chassis to form a second relative position.

For example, if the environment information does not meet the first contact condition, for example, the robot is in a scenario in which the robot is going upstairs or downstairs, the current center of gravity of the robot may be within a non-safe range.

In some embodiments, based on the environment information of the ambient environment acquired by the robot in this embodiment of this application, a machine learning model is invoked to classify the environment information, to obtain a movement manner type of the robot to which a current environment type is applicable, and switch a current movement manner of the robot to a movement manner applicable to the current environment type.

The following explains and describes a machine learning model for controlling a robot. Types of the machine learning model include: a linear regression model, a decision tree model, a support vector machine model, and a deep learning model.

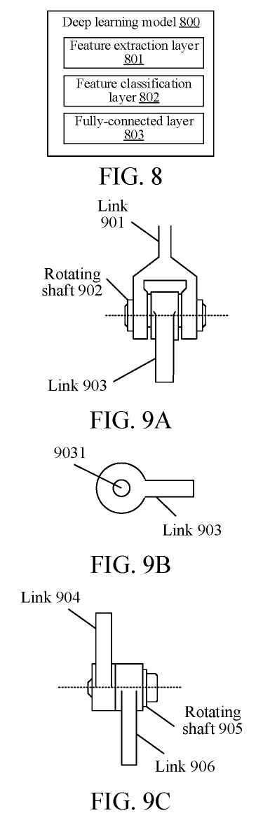

Referring to FIG. 8, FIG. 8 is a schematic structural diagram of a machine learning model according to an embodiment of this application. In this embodiment of this application, an example in which the robot learning model is a deep learning model 800 in FIG. 8 is used for description. The machine learning model may be the deep learning model 800 that includes a feature extraction layer 801, a feature classification layer 802, and a fully-connected layer 803. The feature extraction layer 801 may be a convolutional neural network including a plurality of convolutional layers, which is configured for performing feature extraction on environment information acquired by the sensor of the robot to obtain environment features. The feature classification layer 802 may be a recurrent neural network, which is configured for classifying the environment features to obtain an environment type corresponding to the environment feature. The fully-connected layer can perform mapping from feature space to sample label space, that is, map the learned feature representations to the labels of specific samples. In this embodiment of this application, the fully-connected layer 803 is configured to map different environment types to different types of motion data of the robot. The different types of motion data of the robot respectively represent different motion states of the robot, and the motion data includes a position of each component of the robot, angle information between the components, a movement speed, and motor driving power.

In some embodiments, the deep learning model for controlling the robot may be trained in the following manner: obtaining training data, the training data including sample motion data, sample environment information, and a mapping relationship between the sample environment information and the sample motion data; invoking an initialized deep learning model based on the sample environment information to perform prediction, to obtain predicted motion data of the robot in an environment corresponding to the sample environment information; and determining, based on a difference between a type of the predicted motion data and a type of the sample motion data, a cross entropy loss of the deep learning model, and performing, based on the cross entropy loss, back propagation on the initialized deep learning model, to obtain a trained deep learning model.

In some embodiments, in response to the environment information of the environment of the robot meeting a second contact condition, a fourth relative position is controlled to be formed between a first part and a second part of the first mechanical leg of the robot. An angle formed between the second part and the first part in the fourth relative position is an acute angle, and first moving wheels or a second surface of the support chassis is not in contact with a support surface.

For example, the second contact condition includes that: the robot finishes working or an obstacle exists in the current environment. The fourth relative position means that the first mechanical leg is in the folded state. When the current environment meets the second contact condition, controlling the first mechanical leg to be in the folded state can reduce the ground area occupied by the robot. When the robot finishes working, folding the first mechanical leg facilitates storage of the robot. In a case that an obstacle exists in the environment of the robot, folding the first mechanical leg can improve adaptability of the robot in a complex environment, thereby preventing the mechanical leg of the robot from colliding with the obstacle and causing the robot to fall over.

In some embodiments, in response to the robot finishing working or an obstacle existing in the current environment, the fourth part of the second mechanical leg is slid or folded.

In this embodiment of this application, by folding the mechanical legs of the robot, space occupied by the robot is reduced, thereby facilitating storage of the robot and its movement in a narrow environment.

In this embodiment of this application, by switching the support manner of the first mechanical leg of the robot according to the current environment of the robot, the adaptability of the robot in a complex environment is improved, so that the robot can keep balance in the complex environment, and further the robot can adapt to different working environments, thereby improving the working efficiency and universality of the robot.

An exemplary application of the robot control method according to this embodiment of this application in an actual application scenario will be described below.

In the related art, with continuous development of robot technologies, the movement capability of a robot has garnered significant attention. In the related art, the robots move either in a legged or wheeled locomotion manner. A legged robot has the characteristic of high adaptability to terrains, and a wheeled robot has the advantage of high stability of locomotion. However, the related art lacks fusion of wheeled locomotion and legged locomotion, and there are relatively few robot forms that fuse wheeled locomotion and legged locomotion. For most existing wheeled-legged mobile robots, a driving wheel is mounted at an end of a leg, and for the rest wheeled-legged mobile robots, a wheel is mounted at a knee joint of the leg of the robot.

The existing wheeled-legged robots are mostly four-legged robots. Wheels are mounted on the soles, the knee joints, or the legs of the four-legged robot to form the wheeled-legged robot. There are also some two-wheeled robots where the wheels serve as both legs and wheels. When an upper body of a robot is provided with mechanical arms, the mechanical arms are configured to perform an operation function in a corresponding application scenario. If the robot is supported only by the wheels, the center of gravity of the robot is unstable, and the operation function is unstable.

To solve the foregoing problem in the related art, an embodiment of this application provides a robot that uses a wheeled-legged mechanism. The robot not only has characteristics of a wheeled mobile robot, but also has characteristics of a legged mobile robot. The wheeled locomotion helps to improve the flexibility and efficiency of locomotion of the robot, and the legged locomotion helps to improve the adaptability of the robot to terrains and can provide a stable platform for operations of the robot.

The robot provided in this embodiment of this application includes a robot body, a base, and a leg assembly including a plurality of mechanical legs.

The robot provided in this embodiment of this application will be described below with reference to the accompanying drawings. Referring to FIG. 5A, FIG. 5A is a schematic structural diagram of a base and mechanical legs of a robot according to an embodiment of this application. FIG. 5A is a simplified structural diagram of the base and the leg assembly in FIG. 4A.

The base 53 is connected to the first mechanical leg 521 by using the second connector 532, and the base 53 is connected to the second mechanical leg 522 by using the second connector 533. In FIG. 5A, an example in which the second connector is a revolute joint is used for description.

In this embodiment of this application, an example in which the robot includes three mechanical legs is used for description, and the robot includes two second mechanical legs and one first mechanical leg. The first mechanical leg includes a first part 5211, a second part 5212, a support chassis 524, and first moving wheels 525. The first part 5211 is connected to the second part 5212 by using a second rotating shaft 5213. The second part 5212 is connected to a first surface of the support chassis 524 by using a first rotating shaft 523. A second surface of the support chassis 524 is a plane. The first surface of the support chassis is further provided with the first moving wheels 525.

In this embodiment of this application, an example in which there are two first moving wheels 525 is used for description. In specific implementation, there may be multiple first moving wheels 525. The first moving wheels 525 may be driven castor wheels, or the first moving wheels 525 may be driving wheels. In this embodiment of this application, in FIG. 5A, an example in which a direction that the first mechanical leg faces is a backward direction of the robot is used for description, and the first moving wheels 525 are arranged at the front relative to the first mechanical leg. If the first mechanical leg is the front leg of the robot, which faces the front of the robot, the first moving wheels 525 are arranged at the rear relative to the first mechanical leg.

For example, the first mechanical leg 521 may perform a bending action based on the second rotating shaft 5213, and the first mechanical leg 521 is closer to the axis of the base 53 than the second mechanical legs. When the first mechanical leg and the second mechanical legs are in the same plane, the two second mechanical legs are located on two sides of the first mechanical leg. The first mechanical leg 521 may be referred to as an inner leg, and the second mechanical legs as outer legs.

In this embodiment of this application, the structures of the two second mechanical legs are the same, and the second mechanical legs are mounted and arranged on two sides of the base 53. Each of the second mechanical legs 522 includes a second moving wheel 526, a third part 5221, a fourth part 5222, and a third connector 5223. The third part 5221 is connected to the fourth part 5222 by using the third connector 5223. The second moving wheel 526 is a driving wheel, and is driven by a driving motor of the robot to move.

For example, in FIG. 5A, an example in which the third connector is a prismatic joint is used for description. When the third connector is a prismatic joint, the second mechanical leg 522 in FIG. 5A is a prismatic driver leg. The fourth part 5222 slides in parallel on the third part 5221 based on the prismatic joint. The prismatic joint is an element such as a slide rail.

For example, the first part 5211, the second part 5212, the third part 5221, and the fourth part 5222 may be links.

In some embodiments, referring to FIG. 5B, the third connector 5223 may be a revolute joint.

In some embodiments, the robot body may be connected to the base of the robot based on the first connector, and the first connector is rotatable. The robot body may alternatively be fixed to the base by using a link.

Referring to FIG. 6, FIG. 6 is a second schematic structural diagram of a robot body of a robot according to an embodiment of this application. FIG. 6 is a simplified structural diagram of the robot body 51 in FIG. 4A.

The robot body includes a first link 512, a second link 513, a third link 516, and a plurality of mechanical arms 511. In this embodiment of this application, an example in which there are two mechanical arms 511 is used for description. According to a specific application scenario, structures of the two mechanical arms may be different or the same, and the two mechanical arms are respectively disposed on opposite sides of the first link 512. The mechanical arms 511 are connected to an end of the second link 513 away from the base of the robot by using fifth connectors 515. The second link 513 is connected to the first link 512 by using a fourth rotating shaft 514. An end of the first link 512 close to the base of the robot is connected to the base by using a first connector 531. The fifth connector 515 may be a ball joint. The first connector 531 may be a ball joint. The mechanical arms 511 may be provided with structures such as a revolute joint or a mechanical hand, thereby allowing the robot to perform different operations.

For example, the description is made by using a point A in FIG. 6 as a target point and a center point B of the first connector 531 as a reference point. Assuming that the robot is a humanoid robot, the point A is similar to the central position of shoulders of the robot. For the shoulders, what matters more in space is the expansion of the motion space. A large range of movement of the point A relative to the point B can be implemented by using the first link 512, the second link 513, the third link 516, and the revolute joint and the ball joint between the links. With the two mechanical arms mounted on shoulders, the motion space for operations of the robot can be greatly increased.

For ease of understanding, referring to FIG. 4A to FIG. 4C below, FIG. 4A to FIG. 4C are schematic structural diagrams of a robot according to an embodiment of this application. FIG. 4A to FIG. 4C are structural diagrams of modeling of the robot corresponding to FIG. 5A, FIG. 5B, and FIG. 6 above.

FIG. 4A shows a case in which the second moving wheels 526 of the second mechanical legs 522 and the second surface of the support chassis 524 of the first mechanical leg 521 are in contact with the support surface (for example, the ground), which is applicable to a scenario in which the robot stands still and the mechanical arms perform related operations, for example, a case in which the ground is a rough surface or the robot is located on stairs. The support chassis 524 contacts the ground, so that the robot can be prevented from losing balance.

FIG. 4B shows a case in which the second moving wheels 526 of the second mechanical legs 522 and the first moving wheels 525 of the first mechanical leg 521 are in contact with the support surface (for example, the ground), which is applicable to a scenario of wheeled locomotion, for example, a case in which the ground is a smooth plane.

In some embodiments, when the first moving wheels contact the ground, the support chassis and the first mechanical leg may be non-parallel, and the driving motor of the revolute joint continuously drives the revolute joint such that the revolute joint is fixed at a certain angle. When the first moving wheels contact ground, the support chassis and the first mechanical leg may be parallel. When the first surface of the support chassis flips to the first part of the first mechanical leg, due to the forward movement of the robot, the support chassis is in limited contact with the first mechanical leg under the action of force.

FIG. 4C shows a scenario of two-wheeled locomotion. The first mechanical leg 521 is folded by using the second rotating shaft 5213, and the robot is supported by the second mechanical legs. This form is applicable to the following scenarios: 1) the ground is smooth, which is applicable to two-wheeled locomotion; and 2) the robot stops working, and the first mechanical leg of the robot is folded, which reduces the ground area occupied by the robot and facilitates storage of the robot.

In some embodiments, the first mechanical leg may be folded not only toward the front of the robot as shown in FIG. 4C (that is, after the folding operation is performed, the second surface of the support chassis of the first mechanical leg faces the forward direction of the robot), but also toward the back of the robot (that is, after the folding operation is performed, the second surface of the support chassis of the first mechanical leg faces the direction opposite to the forward direction of the robot), which mainly depends on whether the environment of the robot allows the robot to perform folding in the actual scenario. For example, if no obstacle that hinders motions of the robot exists within a particular range centered on the robot, the first mechanical leg of the robot may be folded forward or backward. If an obstacle that hinders the robot to perform the folding operation exists in front of the robot, the first mechanical leg of the robot is folded backward.

In some embodiments, contrary to FIG. 4C, the second surface of the support chassis may be in contact with the support surface, the entire robot may be supported only by the first mechanical leg, and the second mechanical legs may slide based on the prismatic joint, so that a total length of the second mechanical legs is reduced and the second moving wheels are suspended.

In this embodiment of this application, the first mechanical leg is disposed on the robot, and the first mechanical leg is capable of switching between the wheels and the planar chassis as the support, thereby enriching locomotion manners of the robot. The robot can perform motions based on the two wheels, and can also be supported by a plurality of support points contacting the ground at the same time, so that the robot is more stable during movement.

The following continues to describe an exemplary structure of which the robot control apparatus 455 provided in this embodiment of this application is implemented as software modules. In some embodiments, as shown in FIG. 2A, the software modules in the robot control apparatus 455 that are stored in the memory 450 may include: an obtaining module 4551, configured to obtain environment information of a current environment of the robot; and a switching module 4552, configured to control, in response to the current environment of the robot meeting a first contact condition, a first rotating shaft of a first mechanical leg of the robot to rotate a support chassis to form a first relative position. The switching module 4552 is further configured to control, in response to the current environment not meeting the first contact condition, the first rotating shaft of the first mechanical leg of the robot to rotate the support chassis to form a second relative position.

An embodiment of this application provides a computer program product. The computer program product includes computer programs or computer-executable instructions. The computer programs or the computer-executable instructions are stored in a computer-readable storage medium. A processor of an electronic device reads the computer programs or the computer-executable instructions from the computer-readable storage medium, and the processor executes the computer programs or the computer-executable instructions, so that the electronic device executes the robot control method according to the embodiment of this application.

An embodiment of this application provides a computer-readable storage medium, having computer-executable instructions stored therein, in which computer-executable instructions or computer programs are stored, which, when executed by a processor, cause the processor to perform the robot control method provided in the embodiments of this application, for example, the robot control method shown in FIG. 3.

In some embodiments, the computer-readable storage medium may be a memory such as a ferroelectric RAM (FRAM), a ROM, a programmable ROM (PROM), an electrically programmable ROM (EPROM), an electrically erasable PROM (EEPROM), a flash memory, a magnetic surface memory, an optical disk, or a CD-ROM, or may be any device including one of or any combination of the foregoing memories.

In some embodiments, the computer-executable instructions may be written in the form of program, software, software module, script, or code in any form of programming language (including compilation or interpretation language, or declarative or procedural language), and the computer executable instructions may be deployed in any form, including being deployed as an independent program or being deployed as a module, an assembly, subroutine, or another unit suitable for use in a computing environment.

For example, the computer-executable instructions may, but do not necessarily, correspond to a file in a file system, and may be stored in a part of a file that saves another program or other data, for example, stored in one or more scripts in a hyper text markup language (HTML) file, stored in a file that is specially used for a program in discussion, or stored in a plurality of collaborative files (for example, files of one or more modules, subprograms, or code parts).

For example, the executable instructions may be deployed to be executed on one electronic device, or on a plurality of electronic devices located at one location, or on a plurality of electronic devices distributed at a plurality of locations and interconnected through a communication network.

Based on the above, according to the embodiments of this application, the body and the mechanical legs of the robot are connected by using the base, so that the mechanical legs and the body of the robot are independent of each other, thereby increasing the flexibility of the robot. The plurality of mechanical legs support the body based on the base. The robot is provided with the plurality of mechanical legs, to enhance balance and stability of the robot. Ends of the plurality of mechanical legs contact the support surface, to meet requirements of more different terrain environments and facilitate the robot to adapt to different environments. The first mechanical leg is disposed in the plurality of mechanical legs, and the first mechanical leg includes the support chassis and the moving wheels, which enables the robot to switch between different support manners. When the plane supporting the floor is in contact with the support surface, the stability of the robot can be improved. When the moving wheels are in contact with the support surface, the moving speed of the robot on the support surface can be improved. The switching between different support manners improves the universality of the robot in the complex environment, thereby improving the working efficiency and moving efficiency of the robot.

The foregoing descriptions are only embodiments of this application and are not intended to limit the scope of protection of this application. Any modification, equivalent replacement, or improvement made within the spirit and scope of this application fall within the protection scope of this application.

What is claimed is:

1. A robot, comprising: a base, a robot body, a leg assembly and a support chassis;
one end of the robot body being connected to the base by using a first connector;
the leg assembly comprising a plurality of mechanical legs, and one end of each of the mechanical legs being connected to the base by using a respective second connector;
a first rotating shaft being disposed on a first mechanical leg of the plurality of mechanical legs, the first rotating shaft being configured to connect the support chassis, the support chassis comprising a first surface and a second surface, first moving wheels being disposed on the first surface of the support chassis, and the first rotating shaft rotating to cause the support chassis to form a first relative position and a second relative position with respect to the first mechanical leg;
in the first relative position, the first moving wheels being configured to contact a support surface; and
in the second relative position, the second surface of the support chassis being configured to contact the support surface.

2. The robot according to claim 1, wherein the first mechanical leg comprises a first part and a second part, the first part is connected to the base by using the second connector, and the first rotating shaft is disposed on an end of the second part away from the robot body; and
the first part is connected to the second part by using a second rotating shaft, and the second rotating shaft is configured to rotate so that a third relative position and a fourth relative position are formed between the first part and the second part, wherein
in the third relative position, the second part is configured to support the first part; and
in the fourth relative position, an angle formed between the second part and the first part is an acute angle, and the first moving wheels or the second surface of the support chassis is not in contact with the support surface.

3. The robot according to claim 1, wherein a second mechanical leg of the plurality of mechanical legs comprises a third part and a fourth part, one end of the third part is connected to the base by using the second connector corresponding to the second mechanical leg, and the other end of the third part is connected to the fourth part by using a third connector.

4. The robot according to claim 3, wherein a second moving wheel is disposed on an end of the fourth part away from the robot body, and the second moving wheel is configured to contact the support surface.

5. The robot according to claim 3, wherein a track is disposed on an end of the fourth part away from the robot body, and the track is configured to contact the support surface.

6. The robot according to claim 3, wherein the third connector is a slide rail; and the fourth part is configured to slide parallel to the third part based on the slide rail.

7. The robot according to claim 3, wherein the third connector is a third rotating shaft; and the fourth part is configured to rotate, based on the third rotating shaft, about an end of the third part away from the robot body.

8. The robot according to claim 3, wherein the third connector is configured to rotate or slide so that the fourth part forms a fifth relative position with respect to the first mechanical leg; and
in the fifth relative position, the second surface of the support chassis of the first mechanical leg is configured to contact the support surface, and the second moving wheel of the fourth part is not in contact with the support surface.

9. The robot according to claim 3, wherein when there are a plurality of second mechanical legs, the plurality of second mechanical legs and the first mechanical leg are dispersedly disposed on the base.

10. The robot according to claim 9, wherein when a quantity of the second mechanical legs is an even number, the second connectors of the plurality of second mechanical legs are disposed on the base around the second connector of the first mechanical leg.

11. The robot according to claim 8, wherein the second connectors respectively corresponding to the plurality of second mechanical legs are disposed in the slide rail on the base, and the second connector corresponding to any of the second mechanical legs is configured to, when moving on the slide rail, change a distance from the adjacent second mechanical leg.

12. The robot according to claim 3, wherein when the second mechanical leg comprises the second moving wheel, a combination of the first moving wheels of the first mechanical leg and the second moving wheel of the second mechanical leg comprises the following types:
the first moving wheels are driven wheels, and the second moving wheel is a driving wheel; and
the first moving wheels are driving wheels, and the second moving wheel is a driving wheel.

13. The robot according to claim 1, wherein the robot body comprises a torso and at least one mechanical arm, and one end of each of the mechanical arms is connected to the torso by using a respective fifth connector.

14. The robot according to claim 13, wherein the torso comprises at least one link; and
when there are a plurality of links, each link is successively connected, every two adjacent links are connected by using a fourth rotating shaft, a quantity of the fourth rotating shafts is less than a quantity of the links, and one end of the link in the plurality of links closest to the base is connected to the base by using the first connector.

15. The robot according to claim 14, wherein when there are a plurality of links and a plurality of mechanical arms, a connection relationship between the links and the mechanical arms is any one of the following cases:
the link is connected to the plurality of mechanical arms by using the different fifth connectors;
the link is not connected to any mechanical arm; and
the link is connected to one of the mechanical arms by using the fifth connector.

16. The robot according to claim 1, wherein the second surface of the support chassis is configured to contact the support surface, and any one of the following structures is disposed on the second surface of the support chassis:
a detachable anti-slip piece is disposed on the second surface;
a plurality of groove components are dispersedly disposed on the second surface; and
a plurality of protrusion components are dispersedly disposed on the second surface.

17. A robot control method, the method being performed by an electronic device, the method being configured for controlling the robot according to claim 1, and the method comprising:
obtaining environment information of a current environment of the robot;
controlling, in response to the environment information of the environment of the robot meeting a first contact condition, the first rotating shaft of the first mechanical leg of the robot to rotate the support chassis to form the first relative position; and
controlling, in response to the environment information not meeting the first contact condition, the first rotating shaft of the first mechanical leg of the robot to rotate the support chassis to form the second relative position.

18. The method according to claim 17, further comprising:
controlling, in response to the environment information of the environment of the robot meeting a second contact condition, the fourth relative position to be formed between the first part and the second part of the first mechanical leg of the robot, an angle formed between the second part and the first part in the fourth relative position being an acute angle, and the first moving wheels or the second surface of the support chassis being not in contact with the support surface.
